(19) United States
(12) Patent Application Publication
(10) Pub. No.: US 2012/0244502 A1
(43) Pub. Date: Sep. 27, 2012

(54) CARD GAME FOR LEARNING THE INTERNATIONAL PHONETIC ALPHABET

(76) Inventor: Marcie Stapp, San Francisco, CA (US)

(21) Appl. No.: 13/070,350

(22) Filed: Mar. 23, 2011

(51) Int. Cl. G09B 1/00

(52) U.S. Cl. 434/171

(57) ABSTRACT

A game and method of play is disclosed to facilitate learning of the IPA. The game is a multiplayer card game where each player receives a specified number of cards. Each card includes a single alphabetic character of the IPA. One player begins by spelling out a phonetic word using one or more of his or her cards. The next player then forms a new phonetic word by interchanging, adding or subtracting one of his or her cards to or from the phonetic word. Each player continues to form new words by interchanging, adding or subtracting a card. If a player is unable to form a new word, that player is out of the game. The game continues until only a single player is left. That player is the winner.

### BACKGROUND

The International Phonetic Alphabet (IPA) is an alphabetic system of phonetic notation devised by the International Phonetic Association as a standardized representation of the sounds of spoken language. The IPA is used by language teachers and students, linguists, speech pathologists and therapists, singers, actors, lexicographers, and a variety of others.

As with any language, learning the symbols of the IPA and their sounds can be a difficult task. It is therefore desirable to provide a system which makes learning the IPA more enjoyable and thus easier. It is also desirable to provide a system which allows players to learn the IPA symbols in depth, rather than merely memorize the symbols.

### SUMMARY

Disclosed herein is a game and method of play to facilitate learning of the IPA. The game is a multiplayer card game where each player receives a number of cards. Each card includes a single alphabetic character of the IPA. One player begins by spelling out a phonetic word using one or more of his or her cards. The next player then forms a new phonetic word by either interchanging a card from his or her hand with a card in the phonetic word, by adding a card from his or her hand to the phonetic word, or by subtracting a card from the phonetic word. The next player may form a different-sounding word by creating a “minimal pair” with the word in play. A minimal pair is two words that differ from each other by the interchanging, addition or subtraction of a single card. In embodiments, the new word also sounds different than the old word. Each player continues to form new words, interchanging, adding or subtracting a card. If a player is unable to form a new word, that player is out of the game. The game continues until only a single player is left. That player is the winner.

In one example, the present technology relates to a method of learning the IPA, the method comprising: (a) distributing cards from a deck of cards to two or more players, the cards having symbols of the IPA formed on a surface of the cards; (b) having a first player form a phonetic word using one or more of the cards distributed to the player in said step (a); (c) having a second player form a new phonetic word having a different sound than the sound of the phonetic word formed in said step (b) by interchanging, adding or subtracting a card to or from the phonetic word formed in said step (b); and (d) repeating said steps (b) and (c) with players taking turns in succession until one player cannot form a new word in said step (c).

In another example, the present technology relates to a method of learning the IPA, the method comprising: (a) printing symbols of the IPA on cards to form a deck of cards; (b) forming a game with the cards printed in said step (a), the game comprising the steps of: (i) distributing cards to two or more players; (ii) having a first player form a phonetic word using one or more of the cards distributed to the player in said step (b)(i); (iii) having a second player form a new phonetic word having a different sound than the sound of the phonetic word formed in said step (b)(ii) by interchanging, adding or subtracting a card to or from the phonetic word formed in said step (b)(ii); and (iv) repeating said steps (b)(ii) and (b)(iii) with players taking turns in succession until one player cannot form a new word in said step (b)(iii).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A through 1D together comprise a flow chart illustrating the operation of an embodiment of the present system.

FIGS. 2A through 2D together illustrate players using cards according to embodiments of the present system to learn the IPA.

FIG. 3 is a front view of a card including a phonetic symbol of the IPA according to embodiments of the present system.

FIG. 4 is a back view of a card according to embodiments of the present system.

FIG. 5 illustrates different symbols and examples of sounds of the IPA.

### DETAILED DESCRIPTION

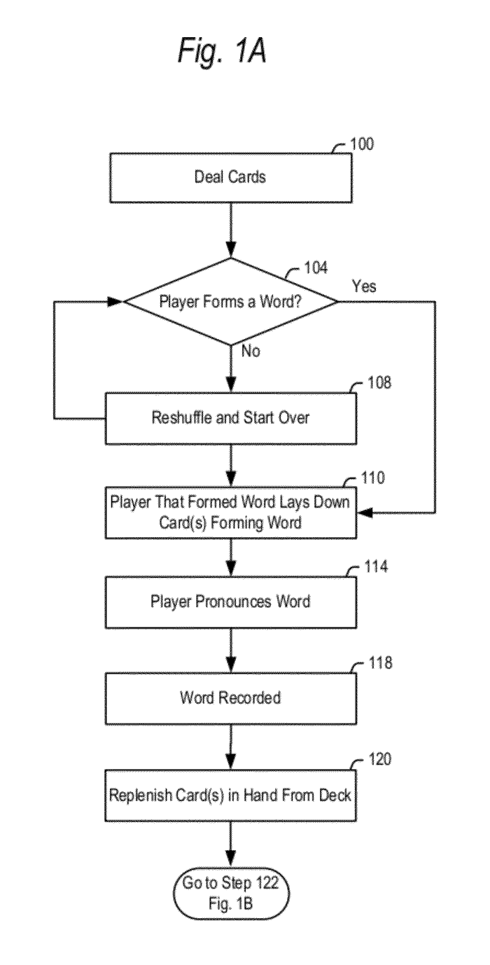

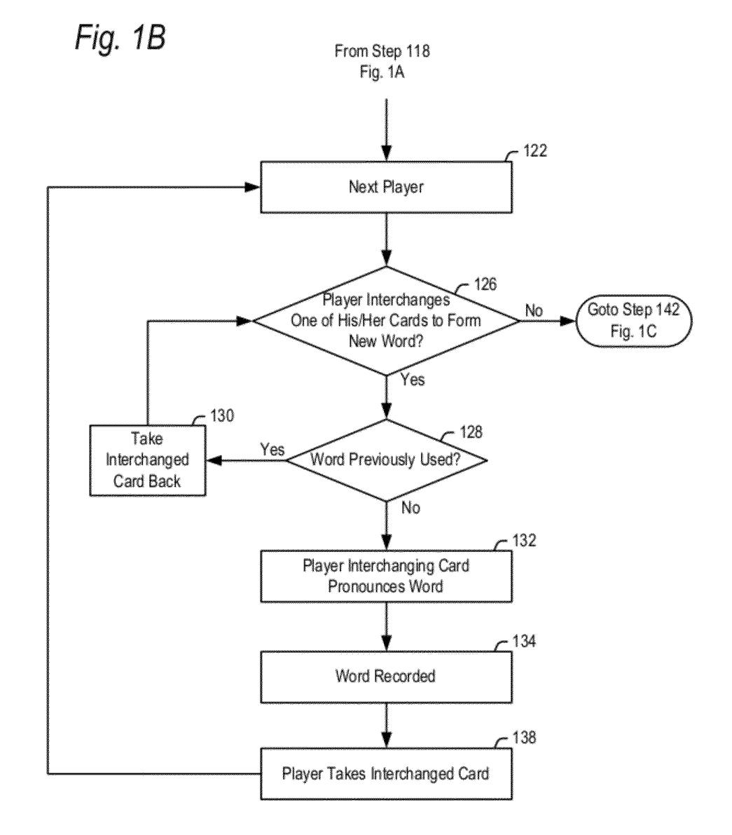

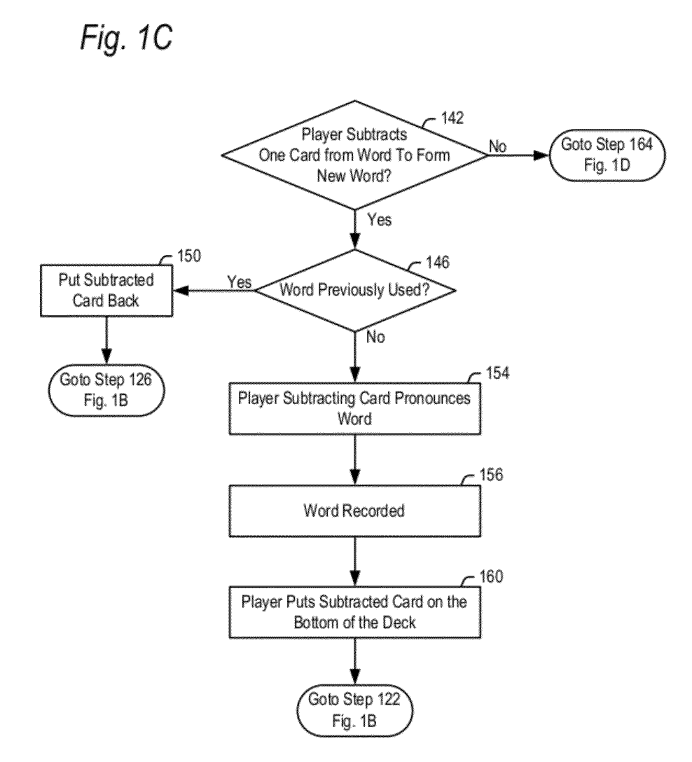

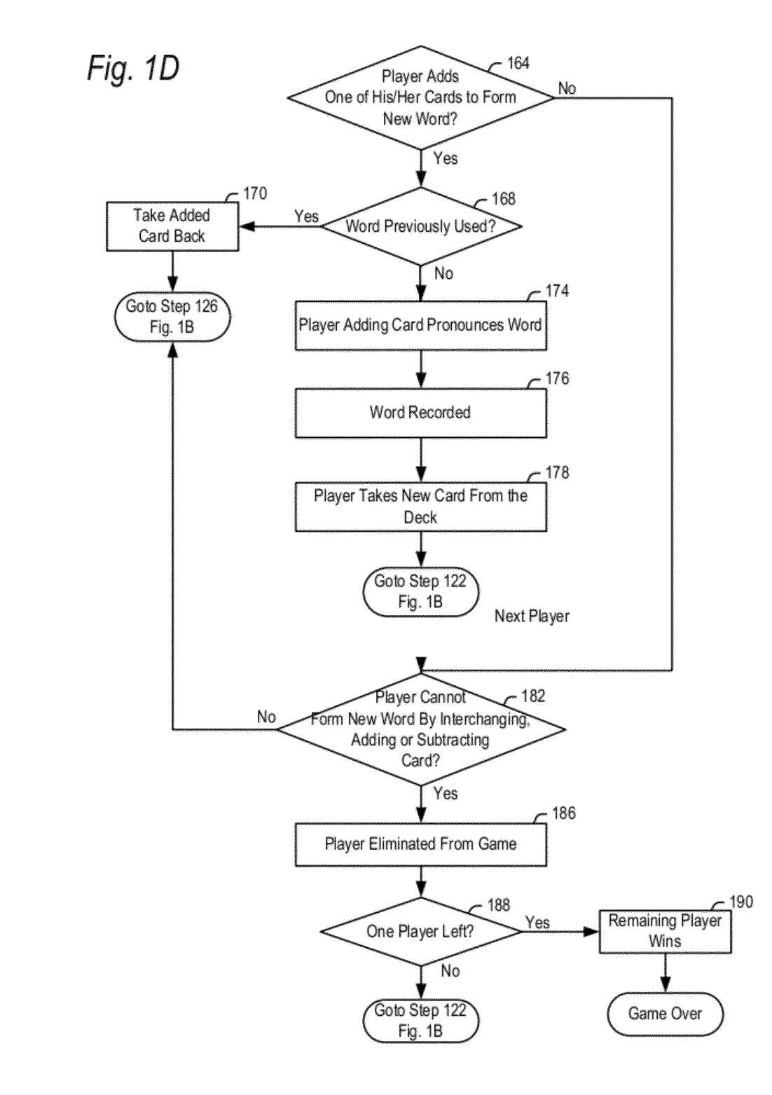

Embodiments of the present technology will now be described with reference to FIGS. 1 through 5, which in general relate to a game and a method of play to facilitate learning of the IPA. It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

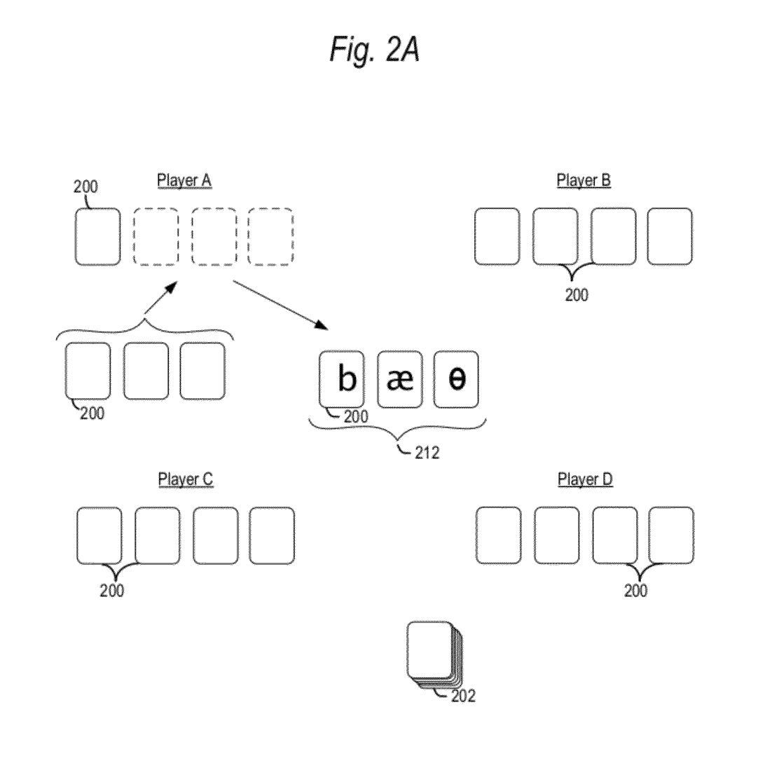

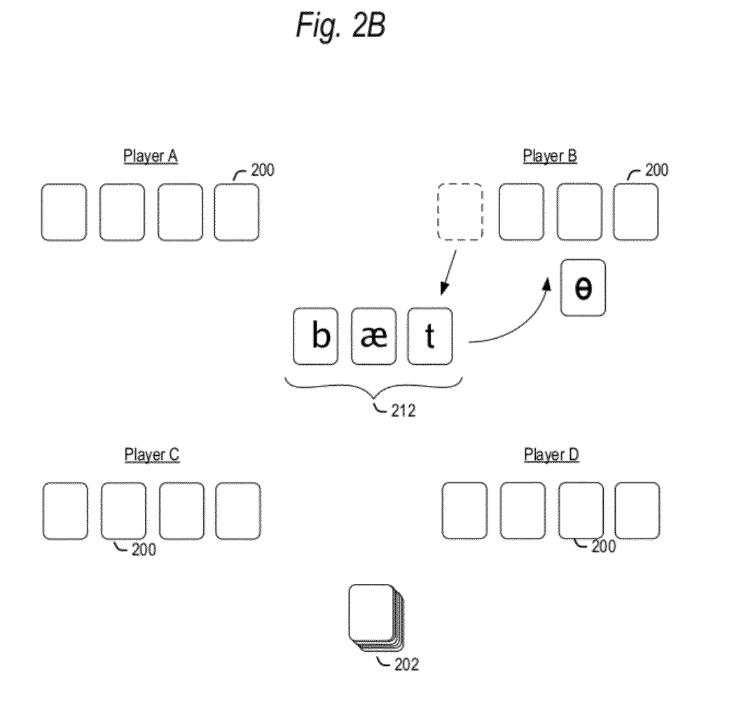

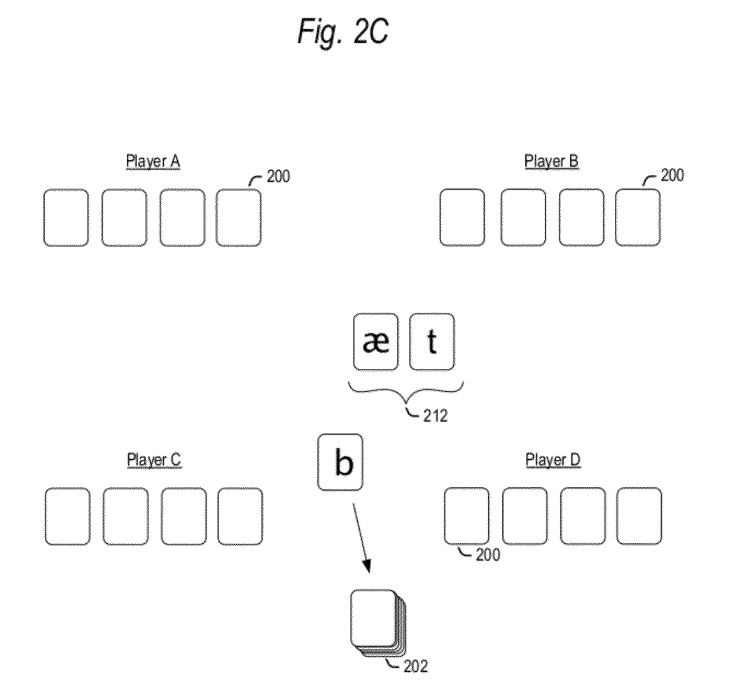

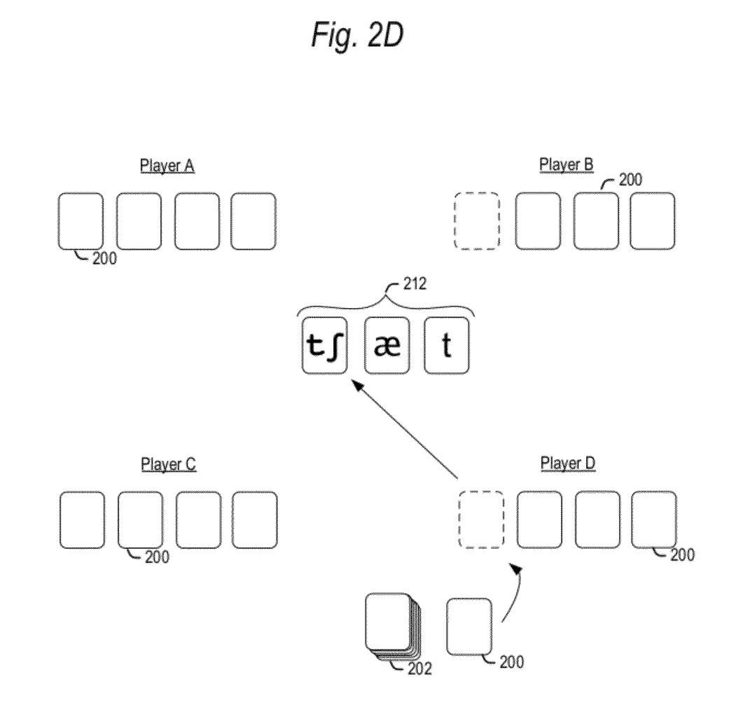

Operation of the present invention will now be explained with reference to the flow charts of FIGS. 1A through 1D and the illustration of players playing a game according to the present system in FIGS. 2A through 2D. In step 100, each player is dealt a number of cards. For example, FIG. 2A shows four players, players A through D, where each is dealt four cards 200 from a deck 202 of such cards. The number of players in the game may vary in different embodiments, and the number of cards each player receives may vary in alternative embodiments. In one example, there may be 39 cards, which correspond to the number of symbols in the English version of the IPA. However, the number of cards 200 initially in deck 202 may vary in embodiments, and may be equal to the number of phonetic symbols which exist in the one or more languages.

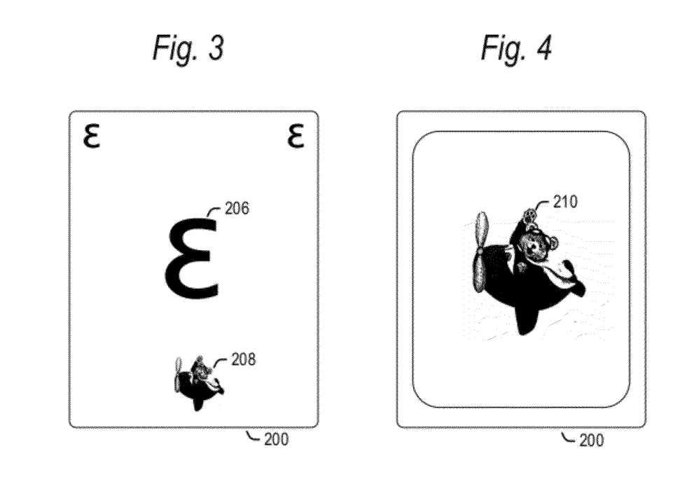

FIGS. 3 and 4 show front and back views, respectively, of an example of one card 200 according to embodiments of the present system. FIG. 3 shows a front view of a card 200 including a phonetic symbol 206 from the IPA. In the example shown, the phonetic symbol 206 is the Greek letter epsilon and is pronounced as the letter “e” as heard in the word “red.” The other cards in deck 202 would include other symbols from the IPA. It is understood that deck 202 may include duplicate cards having the same phonetic symbols in embodiments of the present system.

The front of a card 200 may include other items, such as for example a repeat of a phonetic symbol 206 in one, two, three or four corners of the card, so that when the cards are held in a hand they may be easily identified. Cards 200 may include other items, such as for example graphics 208. As some IPA symbols are inverted versions of a different symbol, the graphic 208 may serve to identify which is the top and which is the bottom of the card. The back of card 200 may similarly include a graphic 210 which may be the same as or different from the graphic 208 on the front of the card. The graphics 208 and/or 210 may be omitted in further embodiments.

Cards 200 may be any of a variety of sizes, such as for example having a length of three and a half inches and a width of two and a half inches. It is understood that the length and/or width may vary in further embodiments. Cards 200 may be formed out of paper, plastic or a variety of other flexible and durable materials.

Referring again to FIG. 1A, once the cards are dealt in step 100, one of the players attempts to form a phonetic word in step 104 with the cards 200 that he was dealt. The players may go in a predefined order to see which player is first able to define a phonetic word, or the word may come from the first player to indicate that they have a word. As an alternative, if no player is able to form a word, the cards are reshuffled and dealt again in step 108. Where a player is able to form a phonetic word, that player lays down the cards, in full view of all players, having the symbols spelling that phonetic word in step 110. In the example of FIG. 2A, player A created a phonetic word 212 using symbols which sound out the word “bath.”

The player forming the initial phonetic word may use any number of his or her cards 200 to form the phonetic word. In embodiments, it may be that if a player succeeds in using all of his or her cards to make the first word of the game, that player wins the game outright. It is understood that different languages will have different IPA symbols and different phonetic words. In embodiments, the words that are used may be from a single language or multiple languages.

In step 114, the player laying down the word (player A in the example of FIG. 2A) may pronounce the word. Each time a player pronounces a phonetic word, the player may also be required to spell the word. A secretary may be appointed who may record the phonetic word in step 118 so that words are not repeated. In step 120, the player that laid down the cards to form phonetic word 212 may replenish the cards into his or her hand from deck 202. In embodiments, players will always maintain the same number of cards, such as for example four cards in the embodiment shown in FIGS. 2A through 2D. In the alternative embodiment, a special card may be provided in the deck, such as for example a bonus card or a joker. If a player picks the bonus card from the deck, that player may be entitled to an extra card from the deck with which to form phonetic words. Thus, in the above example, if Player A picked up the bonus card when picking the three cards from the deck to replenish his or her hand, then the player would be allowed to pick an extra card. Thus Player A would be playing with five cards, while other players played with four. If a player picks the joker from the deck, that card with no phonetic value remains in his hand, thus he would be playing with three cards instead of four.

In step 122 (FIG. 1B) the next player in a predefined order may take his or her turn. In general, a player may interchange a card from his or her hand with a card in phonetic word 212 to form a new word, a player may add a card from his or her hand to the phonetic word 212 to form a new word, or a player may subtract a card from the phonetic word 212 to form a new word. A new phonetic word is one that sounds differently than the previous phonetic word. In embodiments, players are not able to rearrange the cards in phonetic word 212, other than to exchange a single card, add a card at the beginning, end or middle of the phonetic word 212, or subtract a card from the beginning, end or middle of the phonetic word 212.

A player's turn is now explained with reference to FIGS. 1B through 1D. In step 126, a player may interchange a card from his or her hand to form a new word. If the player interchanges a card to form a new word, it is checked in step 128 whether that word was previously used. As noted above, a list of all words used may be kept. If the word was previously used, the player may take back the interchanged card in step 130 and return to step 126 to have the option to interchange a different card to form a different word. In embodiments, homophones of words that have already been played are acceptable as new words. For example, if the word pair has been played, both pear and pare would be acceptable as new words at any point in the same game except immediately following pair, since these words do not produce a different-sounding word with the current phonetic word 212 in play. In further embodiments, homophones are not permitted.

Assuming the newly formed phonetic word was not previously used, the player interchanging the card may pronounce the new word in step 132. The word may be recorded in step 134. The player then takes the interchanged card from phonetic word 212 into his or her hand in step 138.

As an example, in FIG. 2B, Player B interchanges the card containing the symbol “t” from his or her hand with the symbol θ to form a new phonetic word 212 pronounced “bat”. The player takes the card containing the symbol “t” from his or her hand and adds it to the word 212, and takes the card including the symbol θ into his or her hand in exchange. The next player may then take his or her turn in step 122.

Instead of interchanging a card, the player taking his or her turn may instead add or subtract a card from phonetic word 212 to form a new word. For example, if in step 126 the player did not interchange a card, the player may instead opt to subtract a letter from the phonetic word 212 as indicated in step 142 (FIG. 1C).

If the player subtracts a card from phonetic word 212 to form a new word, it is checked in step 146 whether that word was previously used. If the word was previously used, the player may put back the subtracted card in step 150 and return to step 126 to have the option to interchange, add or subtract a different card to form a different word. Assuming the newly formed phonetic word was not previously used, the player subtracting the card may pronounce the new word in step 154. The new phonetic word may be recorded in step 156. The player then takes the subtracted card from phonetic word 212 and puts it at the bottom of the deck in step 160.

As an example, in FIG. 2C, Player C takes the card containing the symbol “b” from the phonetic word 212 to leave the new phonetic word pronounced “at.” Player C then takes the card containing the symbol “b” and puts it at the bottom of the deck 202. The next player may then take his or her turn in step 122 (FIG. 1B).

As noted above, if the player does not interchange or subtract a symbol, the player may instead add a symbol, as explained in step 164 (FIG. 1D). If the player adds a card from his or her hand to phonetic word 212 to form a new word, it is checked in step 168 whether that word was previously used. If the word was previously used, the player may take back the added card in step 170 and return to step 126 to have the option to interchange, add or subtract a different card to form a different word. Assuming the newly formed phonetic word was not previously used, the player adding the card may pronounce the new word in step 174. The new phonetic word may be recorded in step 176. As the player now has fewer cards in his or her hand, the player then takes a new card from the top of the deck 202 in step 178.

As an example, in FIG. 2D, Player D takes a card from his or her hand with the symbol “t∫” and adds it to phonetic word 212 to form the phonetic word pronounced “chat.” Player D then takes the next card from the top of deck 202 to replenish his or her hand. The next player may then take his or her turn in step 122 (FIG. 1B).

The players continue taking their turns, going around and around, until a player is not able to interchange, add or subtract a card to or from the phonetic word 212 (step 182). At that point, that player is eliminated from the game in step 186. In step 188, it is checked whether there is only one player left. If so, that player is the winner in step 190 and the game ends. If there is still more than one player, the next player may then take his or her turn in step 122 (FIG. 1B).

Using the above system, the players may quickly learn the symbols in the IPA in an enjoyable context. Any number of games can be played to determine a winner. For example, in the classroom a single game may be played. Tournaments may also be held where the number of games needed to win could be higher. In embodiments described above, it may be that if a player succeeds in using all of his or her cards to make the first word of the game, that player wins the game outright. While examples of the present system relate to an educational game, it is understood that the present system may additionally or alternatively be purely for enjoyment, recreation and/or a leisure activity.

In embodiments, the following rules may also be used in playing a game to learn the symbols of the IPA:
The symbols [∂] and [ [symbol] ] occur only in unstressed syllables of a multi-syllable word such as about [∂bανt] or father [fα [symbol] ]. In stressed syllables the same sounds would be shown as [Λ] and [ [symbol] ] respectively, as in fun [fΛn], bird [b [symbol] d], dusted [dΛst∂d], further [f [symbol] ]. Further details concerning the transcription of English words may be found in M. Stapp, “The Singers Guide to Languages” (ISBN 0-9650473-0-X), which publication is incorporated by reference herein in its entirety. In The Singer's Guide to Languages, [ [symbol] ] is shown as [oe].
The three true English diphthongs are represented as [εI] [εν] [ [symbol] I] as in my [mαI], how [hαν] and boy [b [symbol] I]. Any other vowel considered to be a diphthong is represented by a single vowel symbol: go [go], day [de].
A vowel preceding r in the same syllable may be represented as either [i] or [I], [e] or [ε], [o] or [ [symbol] ], and [u] or [ν], as in here [hi [symbol] ] [hI [symbol] ], hair [he [symbol] ] [hε [symbol] ] more [mo [symbol] ] [m [symbol] ] and poor [pu [symbol] ] [pν [symbol] ].
The symbol [w] cannot be used in any word where [hw] is also acceptable: which [hwIt∫] may not be represented as [wIt∫], since this would produce the word witch.
Special care must be taken with the vowels [α] and [ [symbol] ], as heard in collar [kαl [symbol] ] and caller [k [symbol] l [symbol] ] for example. These are easily confused and at times both acceptable, as in want [wαnt], [w [symbol] nt] or gone [gαn], [g [symbol] n].

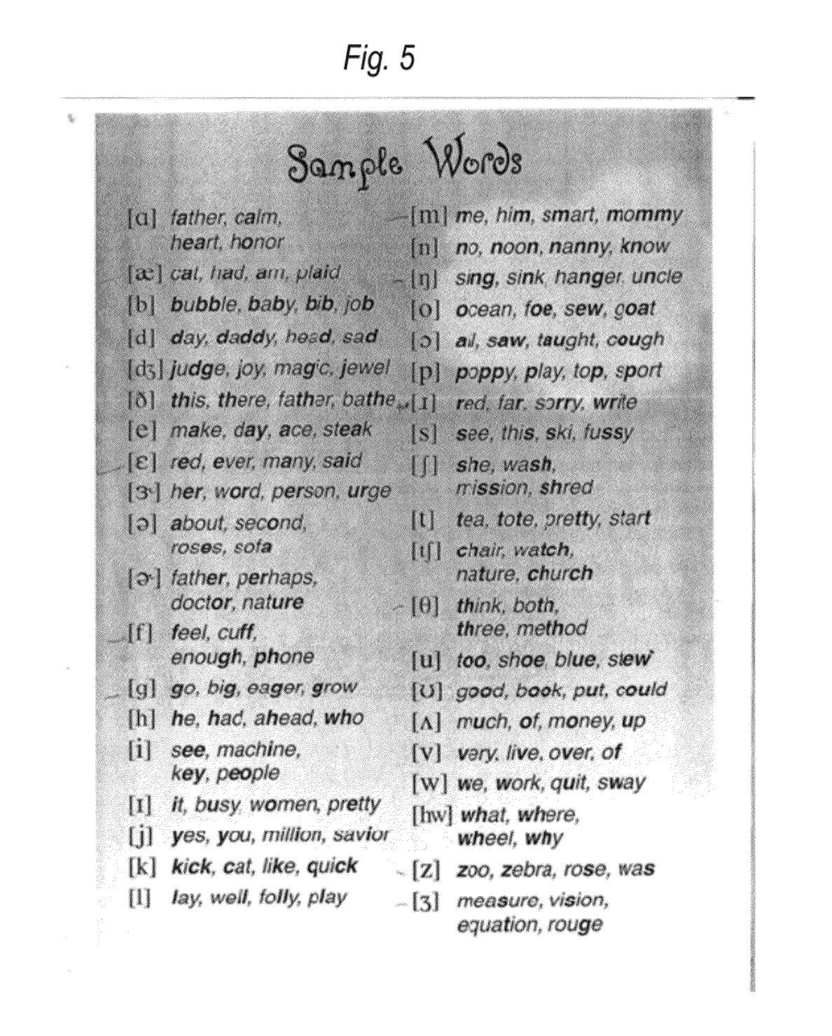

FIG. 5 shows a partial listing of the various symbols of the IPA. Any of those symbols may be used on cards 200.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. A method of learning the International Phonetic Alphabet, the method comprising:
(a) distributing cards from a deck of cards to two or more players, the cards having symbols of the International Phonetic Alphabet formed on a surface of the cards;
(b) having a first player form a phonetic word using one or more of the cards distributed to the player in said step (a);
(c) having a second player form a new phonetic word having a different sound than the sound of the phonetic word formed in said step (b) by interchanging, adding or subtracting a card to or from the phonetic word formed in said step (b); and
(d) repeating said steps (b) and (c) with players taking turns in succession until one player cannot form a new word in said step (c).

2. The method of claim 1, wherein said step (a) comprises the step of distributing four cards to each player.

3. The method of claim 1, wherein the player who is unable to form a new word on his or her turn in said step (d) is eliminated from the game.

4. The method of claim 5, wherein the game continues until all players but one are eliminated, the sole remaining player being the winner of the game.

5. The method of claim 1, further comprising the step of the game ending if a player is able to use all of his or her cards in forming a phonetic word in said step (b).

6. A method of learning the International Phonetic Alphabet, the method comprising:
(a) printing symbols of the International Phonetic Alphabet on cards to form a deck of cards;
(b) forming a game with the cards printed in said step (a), the game comprising the steps of:
(i) distributing cards to two or more players;
(ii) having a first player form a phonetic word using one or more of the cards distributed to the player in said step (b)(i);
(iii) having a second player form a new phonetic word having a different sound than the sound of the phonetic word formed in said step (b)(ii) by interchanging, adding or subtracting a card to or from the phonetic word formed in said step (b)(ii); and
(iv) repeating said steps (b)(ii) and (b)(iii) with players taking turns in succession until one player cannot form a new word in said step (b)(iii).

7. The method of claim 6, wherein said step (a) comprises the step of forming a deck of cards where each symbol of the International Phonetic Alphabet appears once.

8. The method of claim 6, wherein said step (a) comprises the step of forming a deck of cards where one or more symbols of the International Phonetic Alphabet appear on different cards more than once.

9. The method of claim 1, wherein the player who is unable to form a new word on his or her turn in said step (b)(iii) is eliminated from the game.

10. The method of claim 9, wherein the game continues until all players but one are eliminated, the sole remaining player being the winner of the game.
